(19) United States
(12) Patent Application Publication
(10) Pub. No.: US 2007/0151077 A1
(43) Pub. Date: Jul. 5, 2007

(54) Self-restoration hinge

(76) Inventors: Po-Tung Wei, Taipei (TW); Hsiu-Ching Wei, Taipei (TW)

Correspondence Address: LEONG C LEI, PMB # 1008, 1867 YGNACIO VALLEY ROAD, WALNUT CREEK, CA, 94598, US

(21) Appl. No.: 11/324,307

(22) Filed: Jan. 4, 2006

(51) Int. Cl. E05D 11/10

(52) U.S. Cl. 16/320

(57) ABSTRACT

A self-restoration hinge structure is disclosed. The hinge comprises a self-restoration hinge having a linking plate, an internal linking plate, a peg nut and a magnet, characterized in that the linking plate is in combination with the L-shaped linking plate and an axle peg is used to mount the two linking plates at the axle mount thereof, the peg nut secures the axle peg within the axle mount of the two linking plates, the two linking plates are provided with a securing plate A and securing plate B and an extension plate A and extension plate B, the securing plates and the extension plates are mounted with a magnet and are installed on a door panel such that the door can be opened in a 90 degree position, the magnets having the same pole will repel each other and the magnets having different pole will attract each other, thereby when the door is pulled or pushed, the door shall be self-restored to its close position.

### BACKGROUND OF THE INVENTION

(a) Technical Field of the Invention

The present invention relates to hinge structure, and in particular, to a self restoration hinge comprising a first linking plate and a second linking plate respectively mounted with a magnet. The attraction force and repulsion force cause by magnets of different poles and magnets of similar poles allow the self restoration of the hinge secured to door.

(b) Description of the Prior Art

Hinges are mounted to edge or frame of the door to allow the door to be rotated about the hinge.

Conventional hinges have two plates correspondingly linked at one edge thereof and an axle peg is pivotally connecting the linkage of the tube plates. A door mounted with the hinge can be rotated about the hinged to open or to close. It is common that after the door is opened, the door is not closed. In order to solve the problem that the door can be rotated to close after it is opened, a cylinder or a spring is installed to the door, and the action of the spring or the cylinder allows the door to close automatically. However, the installation of the cylinder or the spring to the door planer increases cost of production and it is laborious to install the spring or the cylinder. Therefore, it is an object of the present invention to provide a self-restoration huge which could overcome the drawbacks of the conventional hinge structure.

### SUMMARY OF THE INVENTION

The primary purpose of the present invention is to provide a linking plate, an internal linking plate, a peg nut and a magnet, characterized in that the linking plate is in combination with the L-shaped linking plate and an axle peg is used to mount the two linking plates at the axle mount thereof, the peg nut secures the axle peg within the axle mount of the two linking plates, the two linking plates are provided with a securing plate A and securing plate B and an extension plate A and extension plate B, the securing plates and the extension plates are mounted with a magnet and are installed on a door panel such that the door can be opened in a 90 degree position, the magnets having the same pole will repel each other and the magnets having different pole will attract each other, thereby when the door is pulled or pushed, the door shall be self-restored to its close position.

Still a further object of the present invention is to provide a self-restoration hinge structure, wherein the magnet is a size which could be practically mounted onto the requisite size of the door.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded perspective view of a hinge of the present invention.

FIG. 2 is a perspective view of the hinge in accordance with the present invention.

FIG. 3 is a schematic view showing a preferred embodiment in accordance with the present invention.

FIG. 4 is a schematic view of the preferred embodiment of the present invention.

FIG. 5 is another schematic view of the preferred embodiment of another preferred embodiment.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

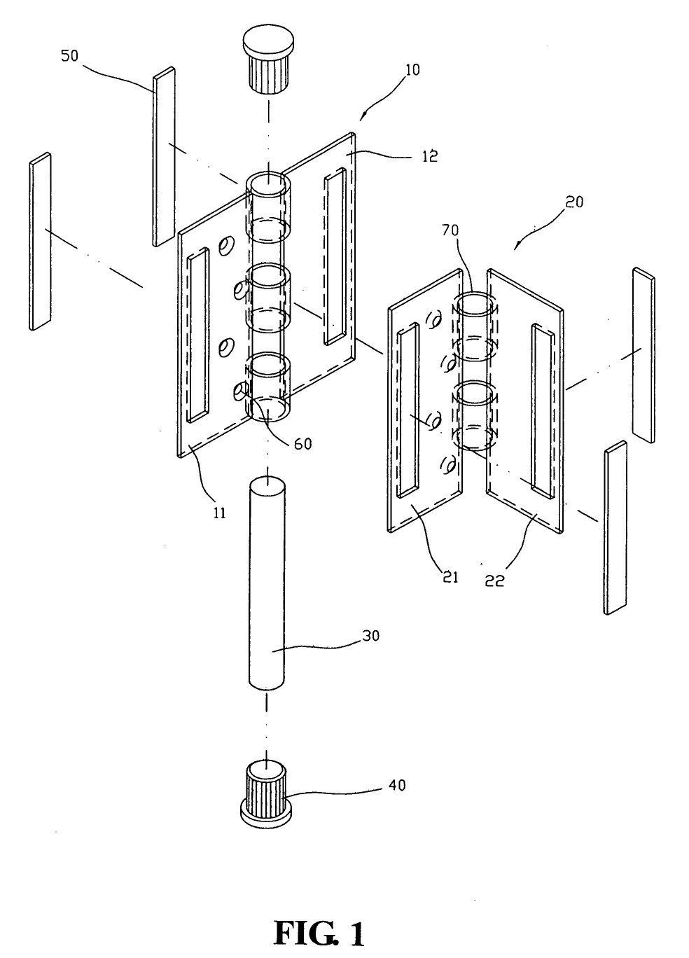

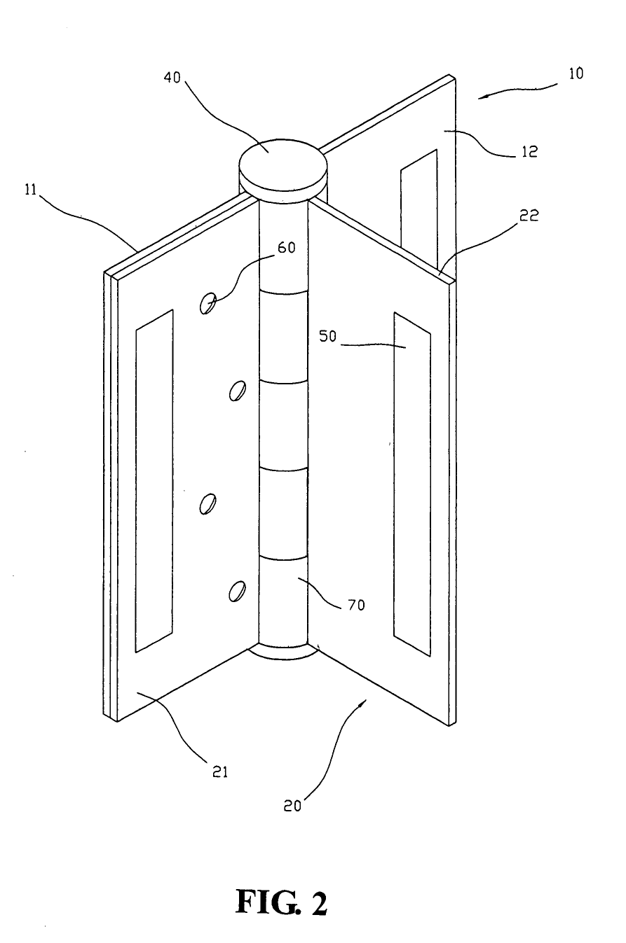

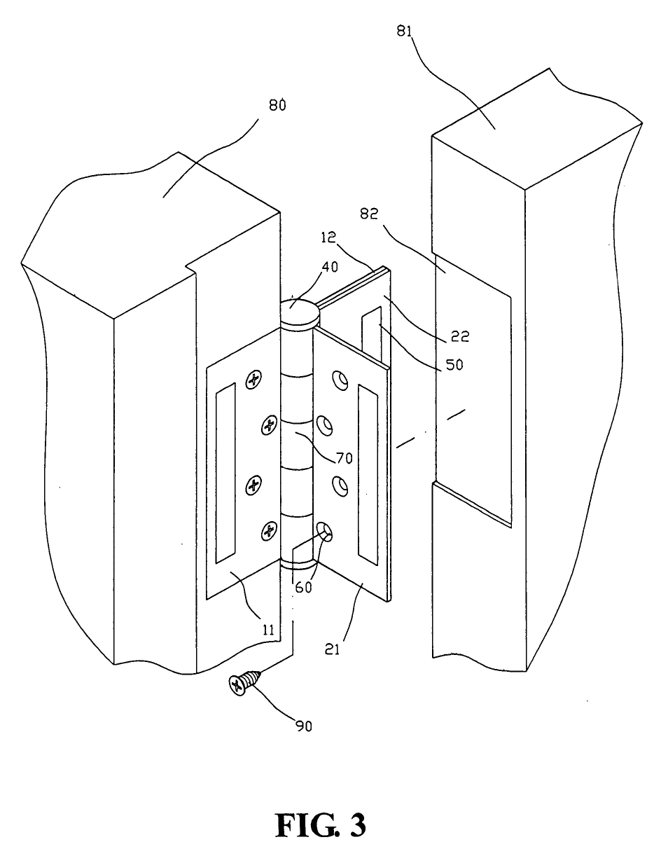

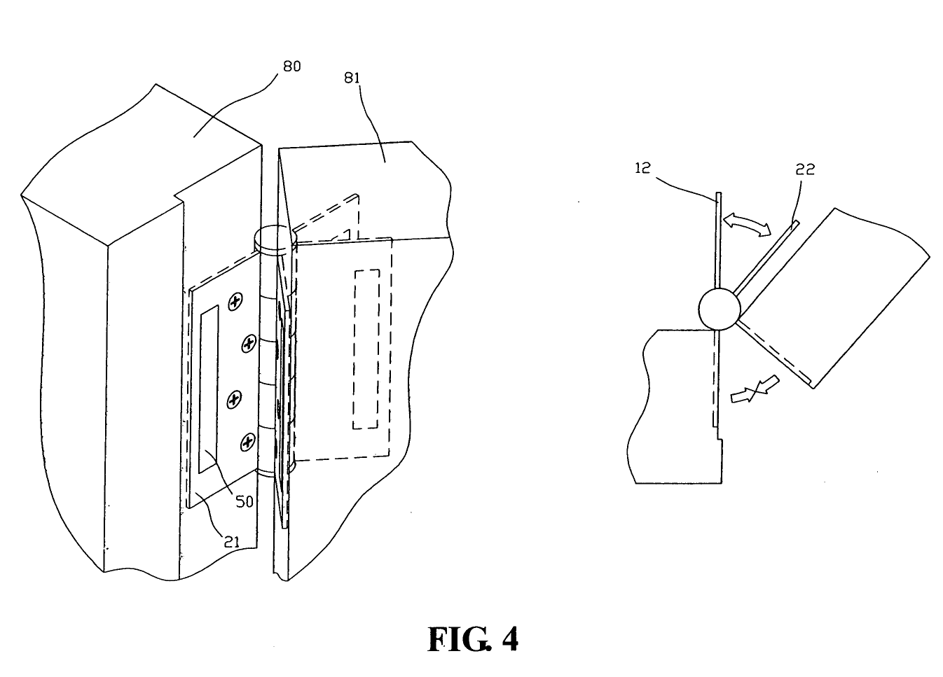

Referring to FIGS. 1 to 5, there is shown a self restoration hinge structure comprising a first linking plate 10 and a second linking plate 20, which is L-shaped, an axle peg 30, a peg nut 40 and a magnet 50.

The first linking plate 10 and the second linking plate 20 are in combination together by the axle peg 30. The axle peg 30 mounts the two linking plate 10, so at the axle mount thereof. The peg nut 40 is used to lock the axle peg 30 such that the two linking plates 10, 20 are pivotally mounted. On the two linking plates 10, 20, securing plates A, B and extension plate A, B are mounted with magnet 50 and that when the hinge is caused to rotate, the securing plate A11 will contact with the magnet on the securing plate B21, or the magnets on the extension plate A12 and the extension plate B22 will contact. The magnetic poles of the magnet at the securing plate A and the securing plate B are designated to be different such that the magnet of the securing plate A will attract the magnet of the securing plate B, and the magnetic poles of the magnets on the extension plate A and the extension plate B are caused to be the same, such that the magnet on the securing plate A and on the securing plate B will repel.

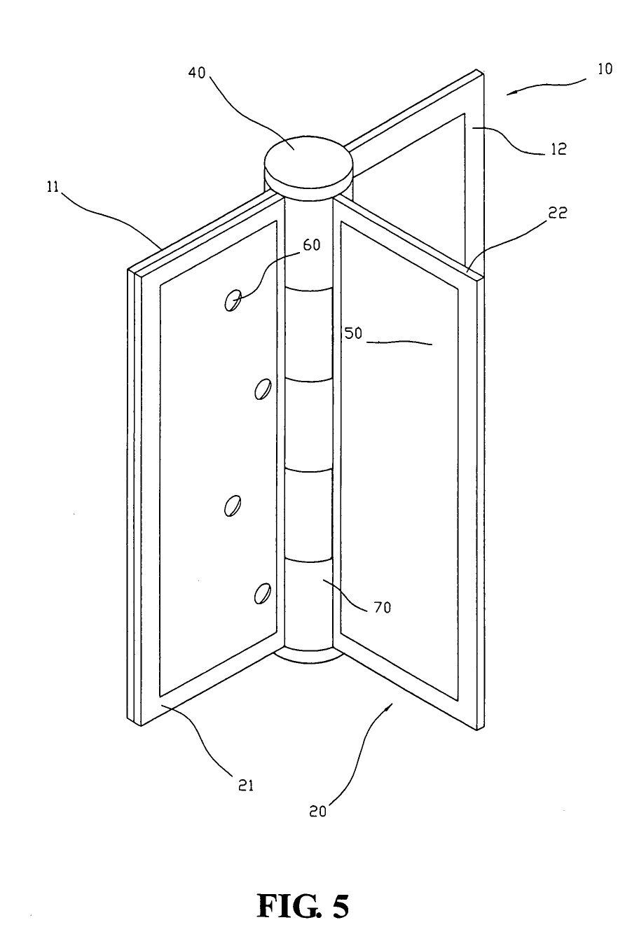

When installation of the door, the securing plates A11, B21 are mounted respective at the slot 82 on the door panel 81 and the door frame 80. Screw 90 is used to secure the hinge at the positioning hole 60 such that the door is hinged to a support and the door panel can be rotated to 90 degree about the hinged position. When the door is opened, the magnets of the extension plate A and the extension plate B in contact with each other, and therefore a repulsion force is generated to push back the door to its original position. In the course the door is restored, the magnets on the securing plates A, B will move close to each other to produce on attraction force. The door which is acted on by the attraction force and the repulsion force, is closed or is self-restored to its close position. The shape of the magnet on the linking plate can be of any size and shape which is appropriate to the required door. The magnet can also be embedded into the linking plates as shown in FIG. 5.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A self-restoration hinge having a linking plate, an internal linking plate, a peg nut and a magnet, characterized in that the linking plate is in combination with the L-shaped linking plate and an axle peg is used to mount the two linking plates at the axle mount thereof, the peg nut secures the axle peg within the axle mount of the two linking plates, the two linking plates are provided with a securing plate A and securing plate B and an extension plate A and extension plate B, the securing plates and the extension plates are mounted with a magnet and are installed on a door panel such that the door can be opened in a 90 degree position, the magnets having the same pole will repel each other and the magnets having different pole will attract each other, thereby when the door is pulled or pushed, the door shall be self-restored to its close position.

2. The self-restoration hinge of claim 1, wherein the magnet is a size which could be practically mounted onto the requisite size of the door.
